(19) United States
(12) Patent Application Publication
(10) Pub. No.: US 2022/0305592 A1
(43) Pub. Date: Sep. 29, 2022

(54) RESIN LAMINATED STEEL PLATE

(71) Applicant: SUBARU CORPORATION, Tokyo (JP)

(72) Inventors: Tomoya YOSHIDA, Tokyo (JP); Kosuke KAWAI, Tokyo (JP)

(73) Assignee: SUBARU CORPORATION, Tokyo (JP)

(21) Appl. No.: 17/695,637

(22) Filed: Mar. 15, 2022

(30) Foreign Application Priority Data
Mar. 25, 2021 (JP) 2021-051854

(51) Int. Cl. B23K 35/368; B32B 15/18; B32B 3/26; B32B 15/085; B32B 3/18

(52) U.S. Cl. CPC B23K 35/368; B32B 15/18; B32B 3/266; B32B 15/085; B32B 3/18; B32B 2307/202; B32B 2250/03; B32B 2250/40; B23K 2103/172

(57) ABSTRACT

A resin laminated steel plate includes steel plates and resin layers. The resin layers are interposed between the steel plates. Each of the resin layer includes resin-absent areas where no resin exists. The resin-absent areas provide gaps in a predetermined range between the steel plates. Resin materials constituting the each of the resin layers are dotted such that the resin-absent areas include areas where no resin material exists.

### CROSS-REFERENCE TO RELATED APPLICATIONS

The present application claims priority from Japanese Patent Application No. 2021-051854 filed on Mar. 25, 2021, the entire contents of which are hereby incorporated by reference.

### BACKGROUND

The disclosure relates to a resin laminated steel plate and in particular relates to a resin laminated steel plate in which resin is interposed between plural metal plates.

Currently, while ordinary iron plates are usually used for panel components for automobiles and so on, resin laminated steel plates in which resin is interposed between plural metal plates are used sometimes. The resin laminated steel plates are widely attracting attention also in consumer electronics industry, electrical machinery industry, construction industry, and civil engineering industry, because of their damping properties, high rigidity and strength, and excellent press formability. For example, in the field of consumer electronics, they are used in washing machines, coolers, lighting fixtures, and air conditioners.

Existing resin laminated steel plates include steel plates and a resin layer between the steel plates. This laminated structure is intended primarily to enhance damping properties. Unfortunately, this structure as it is inhibits spot welding, due to the insulating resin layer. In addition, components of some resins to be used may cause increase in weight, despite the intention of decreasing weight.

To solve the issue of not being able to perform spot welding, existing techniques adopt a method of adding and dispersing conductive substances in a resin layer to impart conductivity to the resin layer. However, even if spot welding is feasible, the following issue still remains. That is, the resin layer rapidly gasifies in a high temperature state during welding, and the produced gas is trapped and bulges the surface of the steel plate into a doughnut shape by its pressure, resulting in deterioration in appearance.

FIGS. 5A and 5B are schematic sectional views illustrating an issue involved with an existing resin laminated steel plate 32. FIG. 5A illustrates a situation of supplying current. FIG. 5B illustrates a situation of welding. The drawings illustrate a case of welding three steel plates, that is, steel plates 12 and 14 of the resin laminated steel plate 32 and another steel plate 16, which are held between a pair of electrodes 20 and 22. A conductive substance 26 that is interposed in a resin layer 19 establishes a power supply path 30 during supplying of current, and therefore, it is possible to perform welding. However, during welding, the resin layer 19 melts because of high temperatures and forms a resin melted part 34 to produce gas. This produced gas is trapped and generates a doughnut-shaped bulge 28 on the steel plate 12 by its pressure, resulting in failure in appearance.

As to this issue, Japanese Unexamined Patent Application Publication (JP-A) No. 2002-219578 discloses a method for performing spot welding on a target steel plate that is a resin coated steel plate having resin coated on at least one surface of a galvanized steel plate. In this method, prior to spot welding, a space of one to four times of the plate thickness of the target steel plate is provided at a part to be welded of the target steel plate between the target steel plates, and spacers with insulation against spot welding are interposed between the target steel plates.

JP-A No. H11-254583 discloses a method for performing butt welding on resin-sandwiched damping steel plates. In this method, an insulator that is made of a heat resistant material is disposed in the vicinity of a side to be welded, instead of the resin between the steel plates. This prevents the resin from gasifying by heat in welding and also prevents the resin from being included in melted metal when the resin melts and flows.

### SUMMARY

An aspect of the disclosure provides a resin laminated steel plate. The laminated steel plate includes steel plates and resin layers. The resin layers are interposed between the steel plates. Each of the resin layer includes resin-absent areas where no resin exists. The resin-absent areas provide gaps in a predetermined range between the steel plates. Resin materials constituting the each of the resin layer are dotted such that the resin-absent areas comprise areas where no resin material exists.

An aspect of the disclosure provides a resin laminated steel plate. The laminated steel plate includes steel plates and resin layers. The resin layers are interposed between the steel plates. Each of the resin layers includes resin-absent areas where no resin exists. The resin-absent areas provide gaps in a predetermined range between the steel plates. The each of the resin layers includes a sheet-shaped member. Holes that penetrate the sheet-shaped member in a thickness direction are dotted in the sheet-shaped member to provide the resin-absent areas.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the disclosure.

FIG. 1A relates to a resin laminated steel plate according to an embodiment of the disclosure and illustrates a plan view of a steel plate on which resin materials are dotted at equal intervals.

FIG. 1B relates to the resin laminated steel plate according to the embodiment of the disclosure and illustrates a schematic sectional view of the resin laminated steel plate.

FIG. 2 relates to the resin laminated steel plate according to the first embodiment of the disclosure and illustrates a schematic sectional view during spot welding.

FIG. 3 relates to a resin laminated steel plate according to an embodiment of the disclosure and illustrates a perspective view of a sheet-shaped member to be held between steel plates.

FIG. 4 relates to a resin laminated steel plate according to an embodiment of the disclosure and illustrates a schematic sectional view during spot welding.

FIG. 5A relates to an existing resin laminated steel plate and illustrates a schematic sectional view during supplying of current in spot welding.

FIG. 5B relates to the existing resin laminated steel plate and illustrates a schematic sectional view during welding in spot welding.

### DETAILED DESCRIPTION

The technique disclosed in JP-A No. 2002-219578 involves preliminarily providing a space between the steel plates at a part to be welded of the resin coated steel plate, and therefore, spot welding is not easy to execute. The technique disclosed in JP-A No. H11-254583 involves providing an insulator made of a heat resistant material and is not designed to weld a part other than a side of a steel plate.

It is desirable to provide a resin laminated steel plate that enables reliable spot welding while maintaining favorable damping properties.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

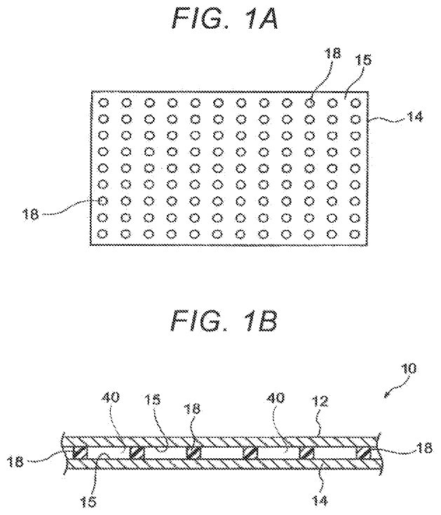

FIGS. 1A and 1B relate to a resin laminated steel plate 10 according to a first embodiment of the disclosure. In the resin laminated steel plate 10 of this embodiment, resin materials 18 are entirely dotted between two steel plates 12 and 14. FIG. 1A illustrates a plan view of the steel plate 14 having a joining surface 15 dotted with the resin materials 18. FIG. 1B illustrates a schematic sectional view of the resin laminated steel plate 10. That is, the resin materials 18 constituting a resin layer are dotted such that resin-absent areas 40 include areas where no resin material 18 exists. Note that although not being denoted by a reference symbol, the resin layer includes the resin material 18 and gaps between the resin materials 18.

The steel plates 12 and 14 are ordinary steel plates each having a thickness of 0.3 to 30 mm. The resin material contains polyolefin based thermoplastic resin, for example.

The resin materials 18 may be dotted on the steel plate 14 in the following manner: for example, applying the resin materials 18 on a film at equal intervals, covering the joining surface 15 of the steel plate 14 with this film, and transferring the resin material 18 onto the steel plate 14. In other cases, a printing technology may be used, or resin may be applied to a steel plate one by one by using a device.

The resin material 18 may have a diameter of 1 mm to 30 mm and a thickness of 40 μm to 4 mm, for example. The size and the thickness may be appropriately chosen in accordance with target damping properties and press formability.

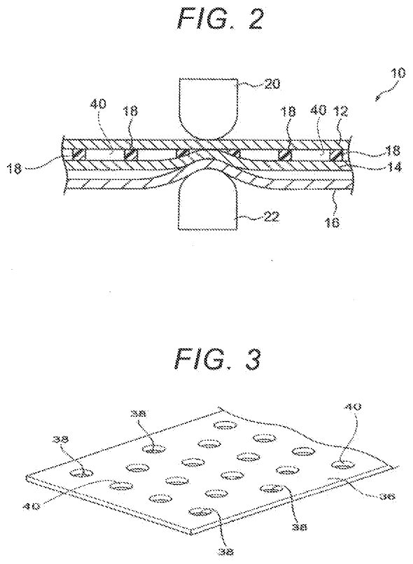

FIG. 2 relates to the resin laminated steel plate 10 according to the first embodiment of the disclosure and illustrates a sectional view during spot welding. In this embodiment, FIG. 2 illustrates an example of spot-welding three steel plates in total which are the steel plates 12 and 14 of the resin laminated steel plate 10 and another steel plate 16.

A part to be spot-welded is an area where no resin material 18 exists. The resin laminated steel plate 10 and the steel plate 16 are held by electrodes 20 and 22, and the lower electrode 22 is raised to narrow a distance between the electrodes 20 and 22. As a result, the three steel plates 12, 14, and 16 come into contact with one another at the same time. That is, when the distance between the electrodes is narrowed, in the resin laminated steel plate 10, the two steel plates 12 and 14 conductively come into contact with each other at a part where no resin exists, and simultaneously, the steel plate 16 also comes into contact with the two steel plates 12 and 14. This makes it possible to perform spot welding.

In one case, a part to be spot-welded may be an area having the resin material 18. Even in this case, the two steel plates 12 and 14 conductively come into contact with each other, for example, on the condition that the diameter of the resin material 18 is smaller than tip diameters of the electrodes 20 and 22. In this manner, the three steel plates 12, 14, and 16 come into contact with one another simultaneously, and current flows through the steel plates 12, 14, and 16, so that spot welding can be performed.

Even when the resin material 18 melts and produces gas during spot welding, a great number of escape routes of the gas exist between the dotted resin materials 18, that is, exist in the resin-absent areas 40, to prevent the steel plate 12 from bulging due to the gas pressure to result in failure in appearance, unlike the existing technique.

The resin materials 18 are dotted at equal intervals and are not scattered nor unevenly distributed on the resin laminated steel plate 10. The resin laminated steel plate 10 thus has reliable damping properties, which do not vary at each part in press molding. Thus, it is possible to achieve a resin laminated steel plate having good usability. In addition, since the resin materials 18 are dotted, the weight can be reduced compared with an existing product having a resin material on the whole surface. The resin material 18 may be distributed at equal intervals only in a direction along linear or curved axis parallel to the steel plate 12, or may be distributed at equal intervals in a plurality of directions along a plurality of linear or curved axes parallel to the steel plate 12. The resin materials 18 may be dotted at unequal intervals so that distribution density of the resin materials 18 in the resin laminated steel plate 10 is substantially uniform.

FIG. 3 relates to a resin laminated steel plate according to a second embodiment of the disclosure. A sheet-shaped member 36 is disposed between two steel plates. The sheet-shaped member 36 has holes 38 at equal intervals. That is, a resin layer includes the sheet-shaped member 36, and the holes 38 that penetrate the sheet-shaped member 36 in a thickness direction are dotted in the sheet-shaped member 36 to provide resin-absent areas 40. The holes 38 may be distributed at equal intervals only in a direction along linear or curved axis parallel to the steel plate 12, or may be distributed at equal intervals in a plurality of directions along a plurality of linear or curved axes parallel to the steel plate 12. The holes 38 may be dotted at unequal intervals so that distribution density of the holes 38 in the resin laminated steel plate 10 is substantially uniform.

The sheet-shaped member 36 may have a thickness of 40 μm to 4 mm. The hole 38 that penetrates the sheet-shaped member 36 in the thickness direction may have a diameter of 1 mm to 30 mm, for example. The thickness of the sheet-shaped member 36 and the size of the hole 38 may be appropriately chosen in accordance with target damping properties and press formability.

With this structure, the resin layer is easily formed by laying the sheet-shaped member 36 between the steel plates. In spot welding, the two steel plates are electrically brought into contact with each other at a hole 38 at a predetermined position. Gas that is produced due to the sheet-shaped member 36 melted during the welding remains in this hole 38. That is, even when the gas is produced due to the resin material melted by heat during the welding, the gap that is provided by the hole 38 of the sheet-shaped member 36 relieves the gas pressure, whereby occurrence of failure in appearance is prevented.

Alternatively, a sheet member may be formed in a grid pattern instead of the holes 38, so as to have rectangular or quadrangular resin-absent areas 40. When gas is produced due to the resin material melted during spot welding, this rectangular or quadrangular resin-absent area 40 relieves the gas pressure and thereby prevents occurrence of failure in appearance.

In the resin laminated steel plate of this embodiment, the holes 38 of the sheet-shaped member 36 are arranged at equal intervals. The resin laminated steel plate thus has reliable damping properties, which do not vary at each part in press molding. Thus, it is possible to achieve a resin laminated steel plate having good usability.

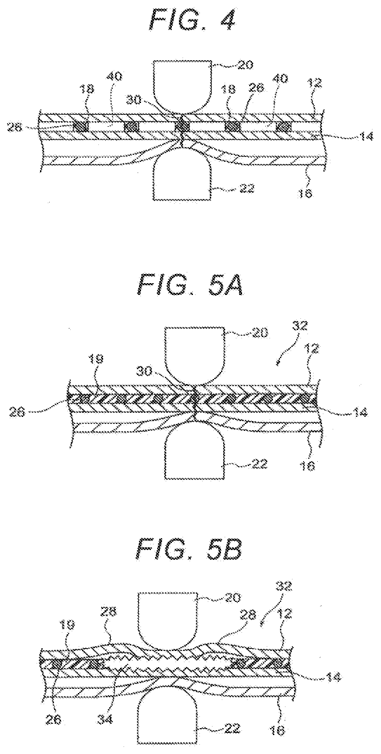

FIG. 4 relates to a resin laminated steel plate according to a third embodiment of the disclosure and illustrates a schematic sectional view during spot welding. In this embodiment, a resin material contains conductive substances. The resin laminated steel plate has the structure of the first embodiment.

With this structure, for example, even when the diameter of the resin material 18 is larger than the tip diameters of the electrodes 20 and 22, and the resin material 18 is positioned exactly between the electrodes 20 and 22 during spot welding, the conductive substance 26 enables current to flow between the electrodes 20 and 22. In FIG. 4, the reference symbol 30 denotes the current path.

In this structure, when gas is produced due to the resin material 18 melted by heat during welding, a great number of escape routes of the gas exist in the resin-absent areas 40 and prevent the steel plate 12 from having a failure in appearance on the surface due to the gas pressure.

The resin laminated steel plate 10 of this embodiment facilitates performing spot welding because the steel plates 12, 14 and 16 come into contact with each other in the resin-absent area during spot welding. In addition, as to the gas produced due to the resin material melted during welding, the resin-absent areas 40 provide escape routes of the gas, and the gaps relieve the gas pressure. Thus, good appearance is obtained while favorable damping properties are maintained, and moreover, the resin laminated steel plate can be reduced in weight. This makes it possible to expand the application range of the resin laminated steel plate in the field of application of composite steel plates.

Note that the disclosure is not limited to the embodiments described above, and various modifications and alterations may be made without departing from the gist of the disclosure. The dotted resin material has a circular shape in the first embodiment. Alternatively, the dotted resin material may have a triangular, pentagonal, or T shape, for example. In the second embodiment, the resin layer includes the sheet-shaped member 36, and the holes 38 that penetrate the sheet-shaped member 36 in the thickness direction are dotted in the sheet-shaped member 36 to provide the resin-absent areas 40. The shape of the hole 38 is not limited to a circular shape but may be a triangular, pentagonal, or T shape. The resin materials are dotted by applying resin to a film and transferring the resin to the steel plate. This method is merely an example, and the resin may be automatically applied one by one by a device. The thickness and the size of the resin material described in the embodiments are mere examples and may be appropriately chosen in accordance with desired damping properties and press formability.

According to the disclosure, the steel plates come into contact with each another in the area where no resin exists in spot welding, so that the resin laminated steel plate of the disclosure enables performing spot welding. Thus, desired damping properties are maintained, and moreover, the resin laminated steel plate can be reduced in weight. This makes it possible to expand the application range of the resin laminated steel plate in the field of application of composite steel plates.

1. A resin laminated steel plate comprising:
steel plates; and
resin layer interposed between the steel plates, wherein
each of the resin layers comprising resin-absent areas where no resin exists, the resin-absent areas providing gaps in a predetermined range between the steel plates, and
resin materials constituting the each of the resin layer are dotted such that the resin-absent areas comprise areas where no resin material exists.

2. A resin laminated steel plate comprising:
steel plates; and
resin layer interposed between the steel plates, wherein
each of the resin layers comprising resin-absent areas where no resin exists, the resin-absent areas providing gaps in a predetermined range between the steel plates,
the each of the resin layers comprises a sheet-shaped member, and
holes that penetrate the sheet-shaped member in a thickness direction are dotted in the sheet-shaped member to provide the resin-absent areas.

3. The resin laminated steel plate according to claim 1, wherein the resin-absent areas are arranged at equal intervals between the steel plates.

4. The resin laminated steel plate according to claim 2, wherein the resin-absent areas are arranged at equal intervals between the steel plates.

5. The resin laminated steel plate according to claim 1, wherein the each of the resin layers contains conductive substances.

6. The resin laminated steel plate according to claim 2, wherein the each of the resin layers contains conductive substances.

7. The resin laminated steel plate according to claim 3, wherein the each of the resin layers contains conductive substances.

8. The resin laminated steel plate according to claim 4, wherein the each of the resin layers contains conductive substances.
